(19) United States
(12) Patent Application Publication
(10) Pub. No.: US 2015/0266307 A1
(43) Pub. Date: Sep. 24, 2015

(54) INK JET SYSTEM

(71) Applicant: SEIKO EPSON CORPORATION, Tokyo (JP)

(72) Inventor: Toshihiro YOKOZAWA, Shiojiri-shi (JP)

(21) Appl. No.: 14/657,305

(22) Filed: Mar. 13, 2015

(30) Foreign Application Priority Data
Mar. 18, 2014 (JP) 2014-055040

(51) Int. Cl. B41J 2/18

(52) U.S. Cl. CPC B41J 2/18

(57) ABSTRACT

Provided is an ink jet system including an ink supply mechanism which supplies a photoreactive ink to an ink jet head, and an ink recovery mechanism which recovers the photoreactive ink emitted from the ink jet head and the ink supply mechanism includes a first ink path through which the photoreactive ink flows. The ink recovery mechanism includes a second ink path through which the photoreactive ink flows. Furthermore, the first ink path has light shielding properties. In addition, an observation area through which the photoreactive ink flowing in the second ink path can be observed is provided in at least a part of the second ink path.

### BACKGROUND

1. Technical Field

The present invention relates to an ink jet system.

2. Related Art

An ink jet system in which a photoreactive ink, such as a photocuring type ink, is supplied, as an ink for recording, to an ink jet head is known (see JP-A-2004-195929, for example). In the case of such a photoreactive ink, it is necessary to shield an ink supply path from light rays such that ink properties are prevented from changing.

However, when the ink supply path is shielded from light rays, it is not possible to check the condition of ink flowing in a flow path. Accordingly, it is not possible to check the flow velocity of ink sucked from an ink jet head or the amount of air-bubbles in the ink. As a result, it is not possible to confirm whether the ink supply condition with respect to the head is normal.

### SUMMARY

An advantage of some aspects of the invention is to provide an ink jet system which allows confirmation of the photoreactive-ink supply condition with respect to a head.

According to an aspect of the invention, there is provided an ink jet system including an ink supply mechanism which supplies a photoreactive ink to an ink jet head, and an ink recovery mechanism which recovers the photoreactive ink emitted from the ink jet head, in which the ink supply mechanism includes a first ink path through which the photoreactive ink flows. In addition, the ink recovery mechanism includes a second ink path through which the photoreactive ink flows, and the first ink path has light shielding properties. Furthermore, an observation area through which the photoreactive ink flowing in the second ink path can be observed is provided in at least a part of the second ink path.

In this case, the photoreactive ink flowing in the second ink path can be observed in a visual manner or a sensing manner. Accordingly, it is possible to check, for example, the flow velocity of the ink sucked from the ink jet head or the amount of air-bubbles in the ink. As a result, it is possible to confirm whether the ink supply condition with respect to the head is normal.

In the ink jet system, it is preferable that the photoreactive ink be an ink for forming an organic electroluminescence element.

In this case, the supply condition of a forming material of an organic electroluminescence element can be confirmed with respect to the head.

In the ink jet system, it is preferable that a detection portion be provided in the observation area to detect the flow condition of the photoreactive ink.

In this case, it is possible to easily and reliably determine the photoreactive-ink flow condition in the second ink path.

In the ink jet system, it is preferable that the photoreactive ink be an ultraviolet-ray curing type ink.

In this case, the supply condition of the ultraviolet-ray curing type ink can be confirmed with respect to the head.

In the ink jet system, it is preferable that a detection portion for detecting the flow condition of the photoreactive ink and a light-shielding material covering the outer surface of the detection portion be provided in the observation area.

In this case, a light-shielding material covers the outer surface of the detection portion. As a result, it is possible to prevent, for example, a problem from occurring in which light rays can enter the inner side of the observation area from outside which may cure the ultraviolet-ray curing type ink adhering to the inner surface of the observation area.

In the ink jet system, it is preferable that the ink recovery mechanism include a plurality of cap members which can abut on a plurality of the ink jet heads, a negative pressure generating unit which causes a portion between the cap member and the ink jet head to enter a negative pressure state, and a valve which is provided in the second ink path connecting the cap member and the negative pressure generating unit.

In this case, the cap member connected to the negative pressure generating unit can be switched by controlling opening/closing of the valve. Thus, in the second ink path connected to the plurality of cap members, the negative pressure generating unit can be used as a common negative pressure generating unit. As a result, it is possible to reduce the number of parts and reduce costs.

In the ink jet system, a plurality of the detection portions are disposed further on the upstream side of the second ink path than the valve, to correspond to the plurality of cap members.

In this case, it is possible to confirm whether the ink supply condition with respect to the respective ink jet head is normal.

In the ink jet system, it is preferable that a plurality of the negative pressure generating units be provided to correspond to the plurality of cap members. In addition, it is preferable that the ink jet system further comprise a control portion which controls the negative pressure generating units based on the detection results from the plurality of detection portions.

In this case, the negative pressure generating units are controlled based on the detection results from the detection portions. As a result, the amount of negative pressure generated can be appropriately adjusted in accordance with the ink flow condition in the second ink path, in such a manner that the ink supply condition with respect to the respective ink jet heads can return to a normal condition.

In the ink jet system, it is preferable that the detection portion be disposed further on the downstream side of the second ink path than the valve.

In this case, the cap member connected to the detection portion can be switched by controlling opening/closing of the valve. Thus, in the second ink path connected to the plurality of cap members, the detection portion can be used as a common detection portion. As a result, it is possible to reduce the number of parts and reduce costs.

### BRIEF DESCRIPTION OF THE DRAWINGS

The invention will be described with reference to the accompanying drawings, wherein like numbers reference like elements.

FIG. 1 is a schematic view illustrating the configuration of a printer according to Embodiment 1.

FIG. 2 is a schematic view illustrating the configuration of a head.

FIGS. 3A and 3B are views illustrating the configurations of principal portions of an ink supply mechanism.

FIG. 4 is a block diagram illustrating the electrical configuration of the printer.

FIG. 5 is a view illustrating the configuration of a principal portion of an ink supply mechanism according to Embodiment 2.

FIG. 6 is a view illustrating the configuration of a principal portion of an ink supply mechanism according to Embodiment 3.

FIG. 7 is a view illustrating the configuration of a detection portion according to a modification example.

### DESCRIPTION OF EXEMPLARY EMBODIMENTS

Hereinafter, embodiments of the invention will be described with reference to the accompanying drawings. In each drawing, the scales of respective members are changed such that the respective members are illustrated, in the drawing, having recognizable sizes. In the following description, an ink jet type printer (hereinafter, referred to as a printer) is exemplified as an ink jet system of the invention.

### Embodiment 1

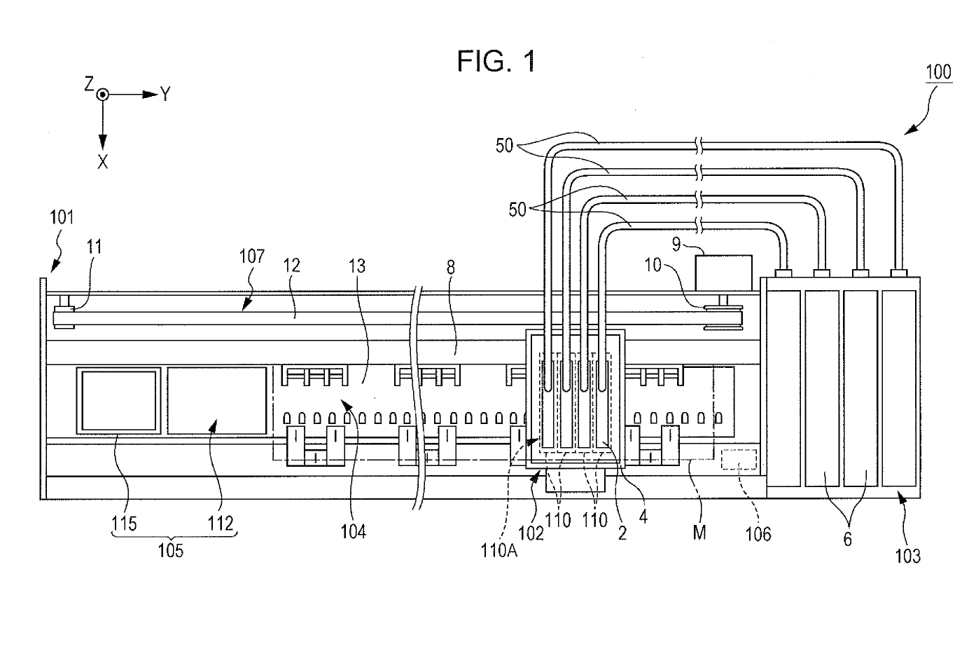

FIG. 1 is a schematic view illustrating the configuration of a printer according to Embodiment 1. A printer 100 is an apparatus which transports a medium M, such as a paper sheet and a plastic sheet, having a sheet shape and performs a printing process, as illustrated in FIG. 1. The printer 100 includes a case body 101, an ink jet mechanism 102, an ink supply mechanism 103, a medium transport mechanism 104, a maintenance mechanism (ink recovery mechanism) 105, and a controller (control portion) 106. The ink jet mechanism 102 discharges ink. The ink supply mechanism 103 supplies ink to the ink jet mechanism 102. The medium transport mechanism 104 transports the medium M. The maintenance mechanism 105 performs a maintenance operation of the ink jet mechanism 102. The controller 106 controls the mechanisms described above.

An X-Y-Z orthogonal coordinate system is used in the following description and the positional relationship between respective components will be described with, appropriately, reference to the X-Y-Z orthogonal coordinate system. In this embodiment, a liquid ejecting direction is set as the Z direction, a head movement direction is set as the Y direction, and a direction perpendicular to both the Z direction and the Y direction is set as the X direction.

When seen in the Z direction, the longitudinal direction of the case body 101 is parallel to the Y direction. The ink jet mechanism 102, the ink supply mechanism 103, the medium transport mechanism 104, the maintenance mechanism 105, and the controller 106 are provided in the case body 101. A platen 13 is provided in the case body 101. The platen 13 is a member for supporting the medium M and is disposed in the X-directional central portion of the case body 101. The platen 13 has a flat surface (not illustrated) directed toward the +Z. The flat surface is used as a surface for supporting the medium M.

The medium transport mechanism 104 is constituted of a transporting roller, a motor for driving the transporting roller, and the like. The medium transport mechanism 104 transports the medium M from the −X side of the case body 101 to the inner portion of the case body 101. Furthermore, the medium transport mechanism 104 discharges the medium M from the +X side of the case body 101 to the outside of the case body 101. In the case body 101, the medium transport mechanism 104 transports the medium M, in such a manner that the medium M passes through the upper side of the platen 13. Furthermore, the transporting time or the transporting amount, for example, of the medium transport mechanism 104 is controlled by the controller 106.

The ink jet mechanism 102 has a head unit 110A and a head movement mechanism 107. The head unit 110A includes a plurality (four, in this embodiment) of heads (ink jet heads) 110. Each head 110 performs an operation of discharging ink (liquid). The ink discharging operation of the head 110 is divided into “ejection” and “emission”. The “ejection” means an operation in which ink is discharged onto the medium M during printing. In contrast, the “emission” means an operation in which ink discharge from the head 110 is performed for a purpose, such as performing a maintenance operation, rather than printing (ejection). The head movement mechanism 107 moves in a state where the head 110 is held in the head movement mechanism 107.

In this case, the ink discharged from the head 110 is a photoreactive ink. The photoreactive ink has properties in which, when the photoreactive ink is exposed to light rays, the quality of the ink changes. Examples of the photoreactive ink include an ultraviolet-ray curing type ink which is cured when the ink is irradiated with ultraviolet rays and a forming material (an organic material) of an organic electroluminescence element (hereinafter, referred to as an organic EL element). When the forming material of an organic electroluminescence element is exposed to light rays, the quality of the material is deteriorated, and thus the life span of the element is reduced. Specifically, an ink including the forming material of an organic EL element is used in this embodiment.

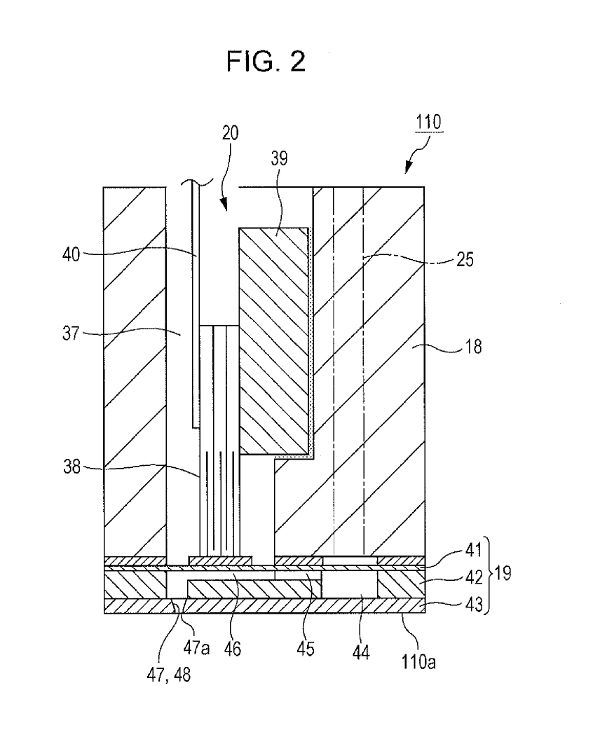

FIG. 2 is a schematic view illustrating the configuration of the head 110. The head 110 includes a head case 18, a flow-path unit 19, and an actuator unit 20, as illustrated in FIG. 2.

The head case 18 is formed in a box shape having a hollow portion. The flow-path unit 19 is bonded to the lower end surface of the head case 18. The actuator unit 20 is accommodated in a hollow portion 37 which is formed in the inner portion of the head case 18. A case flow path 25 is provided in the head case 18, in a state where the case flow path 25 passes through the head case 18, in the height direction.

The upper end of the case flow path 25 is connected to a sub-tank 2 illustrated in FIG. 1. In this embodiment, a plurality (four) of the sub-tanks 2 are provided. The sub-tanks 2 are respectively connected to the heads 110. The lower end of the case flow path 25 communicates with a common liquid chamber 44 in the flow-path unit 19.

Accordingly, the ink in the ink cartridge 6 illustrated in FIG. 1 is supplied to the common liquid chamber 44 side, through the case flow path 25 illustrated in FIG. 2.

The actuator unit 20 has a plurality of piezoelectric vibrators 38 arranged in a ctenidium-like shape, a fixing plate 39 which holds the piezoelectric vibrators 38, and a flexible cable 40 which supplies driving signals from the controller 106 to the piezoelectric vibrators 38. The piezoelectric vibrators 38 are fixed in a state where the lower end portions thereof in FIG. 2 protrude from the lower end surface of the fixing plate 39. Among the surfaces of the fixing plate 39, the surface opposite to the surface to which the piezoelectric vibrators 38 are fixed is adhered to a case inner-wall surface which partitions the hollow portion 37.

The flow-path unit 19 has a diaphragm 41, a flow-path substrate 42, and a nozzle plate 43. The diaphragm 41, the flow-path substrate 42, and the nozzle plate 43 are stacked and adhered to each other. The flow-path unit 19 constitutes a liquid flow path which passes through the liquid supply port 45 and the pressure chamber 46 and extends from the common liquid chamber 44 to a nozzle 47 in the nozzle plate 43. The pressure chamber 46 is formed in a shape in which the longitudinal direction is parallel to the direction perpendicular to the arrangement direction (a nozzle-row direction) of the nozzles 47.

The nozzle plate 43 forms a discharge surface 110a of the head 110. Although not illustrated, a nozzle row 48 constituted of the nozzles 47 aligned in a row is formed in the nozzle plate 43. The nozzle opening 47a of the nozzle 47, through which ink is discharged, is formed in the discharge surface 110a of the nozzle plate 43. The diameter of the nozzle opening 47a is set in the range of, for example, 20 μm and 30 μm.

Returning to FIG. 1, the head movement mechanism 107 has a carriage 4. The carriage 4 holds a plurality (four) of heads 110. The carriage 4 abuts a guide shaft 8 extending in the longitudinal direction (the Y direction) of the case body 101. Both the head 110 and the carriage 4 are disposed above (in the +Z direction) the platen 13.

The head movement mechanism 107 has, in addition to the carriage 4, a pulse motor 9, a driving pulley 10, an idling pulley 11, and a timing belt 12. The driving pulley 10 is rotationally driven by the pulse motor 9. In the case body 101, the idling pulley 11 is provided, in the width direction, on a side opposite to the driving pulley 10 side. The timing belt 12 is wound around both the driving pulley 10 and the idling pulley 11 and is connected to the carriage 4.

The carriage 4 is connected to the timing belt 12 and can move in the Y direction, in accordance with rotation of the timing belt 12. When the carriage 4 moves in the Y direction, the carriage 4 is guided by the guide shaft 8.

The ink supply mechanism 103 supplies ink to the head 110. A plurality (four) of ink cartridges (liquid storage portion) 6 are accommodated in the ink supply mechanism 103. The printer 100 of this embodiment has a configuration (an off-carriage type configuration) in which the ink cartridge 6 is accommodated in a position different from the position of the head 110. The ink supply mechanism 103 has an ink supply portion 50 connecting the head 110 and the ink cartridge 6. The details of the configuration of the ink supply portion 50 will be described below.

The maintenance mechanism 105 is disposed at a home position of the head 110. The home position is set in an area outside the area in which printing is performed on the medium M. In this embodiment, the home position is set in the area located further to a −Y side in the apparatus than the platen 13. The home position is a position at which the head 110 stands by when, for example, the printer 100 is turned off, recording is not performed for a long time, or a maintenance operation is performed.

The maintenance mechanism 105 includes a cap mechanism 112, a wiping mechanism (not illustrated), and a flushing mechanism 115. The cap mechanism 112 covers the discharge surfaces 110a of the respective heads 110. The wiping mechanism wipes the discharge surface 110a. The flushing mechanism 115 performs a flushing process in which ink is emitted through the nozzles 47 of the head 110.

The wiping mechanism includes a wiping member which can face the discharge surface 110a of the head 110. The wiping member wipes the discharge surface 110a, in such a manner that the wiping mechanism removes the ink remaining on the discharge surface 110a or foreign matter adhering to the discharge surface 110a.

When, for example, the driving of the printer 100 is stopped, the cap mechanism 112 functions as a capping mechanism which covers the discharge surface 110a of the head 110 and moisturizes the nozzles 47. An ink absorbent, such as a non-woven fabric and a sponge, capable of absorbing ink may be provided in the cap mechanism 112. In this case, the moisturizing function described above can be favorably performed.

When such a suction operation is finished, the maintenance mechanism 105 wipes the discharge surface 110a, using the wiping member described above. The waste ink emitted from the head 110 to the maintenance mechanism 105 side is recovered by, for example, a waste-ink recovery mechanism (not illustrated).

The flushing mechanism 115 includes, for example, a flushing box (not illustrated). The flushing mechanism 115 causes ink to be forcibly emitted, toward the flushing box, from the nozzles 47 of the head 110, in such a manner that the flushing mechanism 115 prevents, in advance, clogging from occurring due to thickening ink.

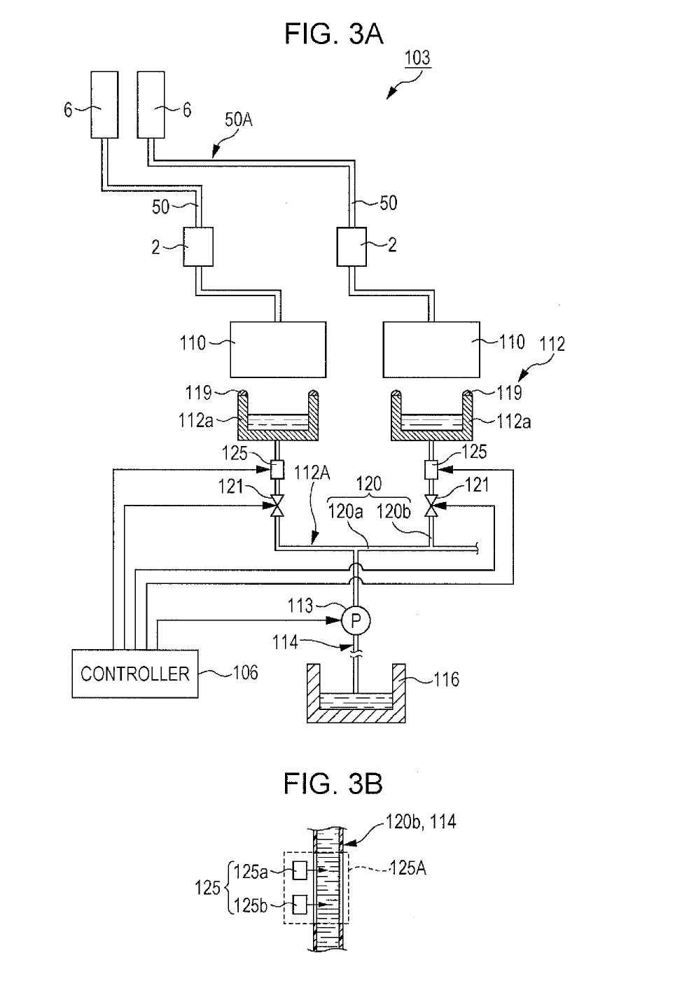

FIG. 3A is a view illustrating the configurations of both the ink supply mechanism 103 and the maintenance mechanism 105. FIG. 3B is a view illustrating the configuration of a principal portion of the maintenance mechanism 105. An ink supply path and an ink recovery path relating to two heads 110 are illustrated in FIG. 3A.

The ink supply portion 50 according to this embodiment includes an ink supply path (first ink path) 50A through which the ink flows. The ink supply paths 50A constitute the primary parts of main flow paths 51, each of which connects the ink cartridge 6 and the head 110, as illustrated in FIG. 3A. The main flow path 51 supplies ink from the ink cartridge 6 to the head 110, via the sub-tank 2.

In this embodiment, the ink supply path 50A has light shielding properties, throughout the entirety of the ink supply path extending from the ink cartridge 6 to the head 110. Specifically, the main flow path 51 is constituted of a black tube having light shielding properties. Both the ink cartridge 6 and the sub-tank 2 are constituted of a material not having optical transparency. The main flow path 51 may have a configuration in which a member having light shielding properties covers the periphery of a tube having optical transparency. Furthermore, for example, metallic covers cover the peripheries of both the ink cartridge 6 and the sub-tank 2 formed of a transparent resin material, in such a manner that light shielding properties may be imparted to both the ink cartridge 6 and the sub-tank 2.

In the illustration of FIG. 3A, the main flow path 51 and the other flow paths are bent at a right angle. However, the portion in which the routing direction of the flow path changes is bent with a curvature large enough not to crush the internal flow path of the main flow path 51 and to prevent hindrance of ink flow.

The cap mechanism 112 includes an ink emission path (second ink path) 112A through which the ink emitted from the head 110 flows. The cap mechanism 112 includes a plurality of cap members 112a.

A suction mechanism 113, such as a suction pump, is connected to a plurality of cap members 112a, through a tube 114. The tube 114 is connected to the waste-ink tank 116. The waste-ink tank 116 recovers, through the tube 114, the ink which is emitted into the cap member 112a by the suction operation of the suction mechanism 113. In other words, the tube 114 constitutes a part of the ink emission path 112A for recovering waste ink. The suction mechanism 113 is electrically connected to the controller 106 and the driving of the suction mechanism 113 is controlled.

The cap member 112a has an abutment portion 119 which has a frame shape and abuts on the discharge surface 110a of the head 110. Both the cap member 112a and the abutment portion 119 are constituted of a material having light shielding properties.

The suction mechanism 113 is driven in a state where the cap member 112a is in close-contact with the discharge surface 110a, via the abutment portion 119, in such a manner that The cap mechanism 112 causes ink to be forcibly emitted through the nozzles 47. Thus, the state of the space between the cap member 112a and the discharge surface 110a is changed to a negative-pressure state.

The tube 114 has a branch portion 120 of which one end side is branched into a plurality of separate portions. The branch portion 120 includes a main portion 120a and connection portions 120b connected to the main portion 120a. The number of the connection portions 120b is the same as the number of the cap members 112a. In this embodiment, the number of the connection portions 120b is four. The illustration is simplified in FIG. 3A. Accordingly, only two connection portions 120b are illustrated in FIG. 3A.

In this embodiment, a valve 121 is provided in the connection portion 120b. The valve 121 closes (opens/closes) the internal flow path of the connection portion 120b. The valve 121 is electrically connected to the controller 106, and thus the operation of the valve 121 is controlled.

In the connection portion 120b, a sensor (a detection portion) 125 is provided in a portion between the valve 121 and the cap member 112a, in other words, in the area upstream from the valve 121. In this embodiment, the tube 114 is constituted of a black tube having light shielding properties, except for some parts thereof described below.

In the connection portion 120b of this embodiment, only an installation area 125A of the sensor 125 is transparent or semi-transparent, as illustrated in FIG. 3B. The sensor 125 includes an upstream-side sensor 125a and a downstream-side sensor 125b. The sensors 125a and 125b are constituted of, for example, imaging elements, such as CCD cameras. In the installation area 125A having transparency or semi-transparency, the sensor 125 detects the flow velocity of the ink flowing in the installation area 125A.

The upstream-side sensor 125a and the downstream-side sensor 125b detect (image) ink at two places in the connection portion 120b, in such a manner that the sensor 125 can detect ink flow condition (for example, the flow velocity of ink) in the connection portion 120b.

In the connection portion 120b, there is a concern that light rays may enter the installation area 125A from outside. In this case, there is a concern that the ink flowing in the installation area 125A may be exposed to light rays and the quality of the ink will be deteriorated. Meanwhile, when ink (ink containing a forming material of an organic EL element) used in this embodiment is exposed to light rays, the quality of the ink is deteriorated. However, the exposed ink is not cured or condensed, and thus a problem, such as clogging of a flow path with ink, is prevented from occurring. As a result, even when the ink is exposed to light rays, the flowability (the flow velocity) of ink does not change. Furthermore, in this embodiment, the ink flowing in the connection portion 120b flows into the waste-ink tank 116 and is discarded.

As a result, in this embodiment, even when the quality of ink flowing in the connection portion 120b is deteriorated, this does not influence the detection result of the sensor 125.

The sensor 125 (that is, the upstream-side sensor 125a and the downstream-side sensor 125b) sends the detection result (the captured image) to the controller 106. The controller 106 can determine the ink flow condition in the tube 114 (the connection portion 120b), based on the detection result (the captured image) from the sensor 125.

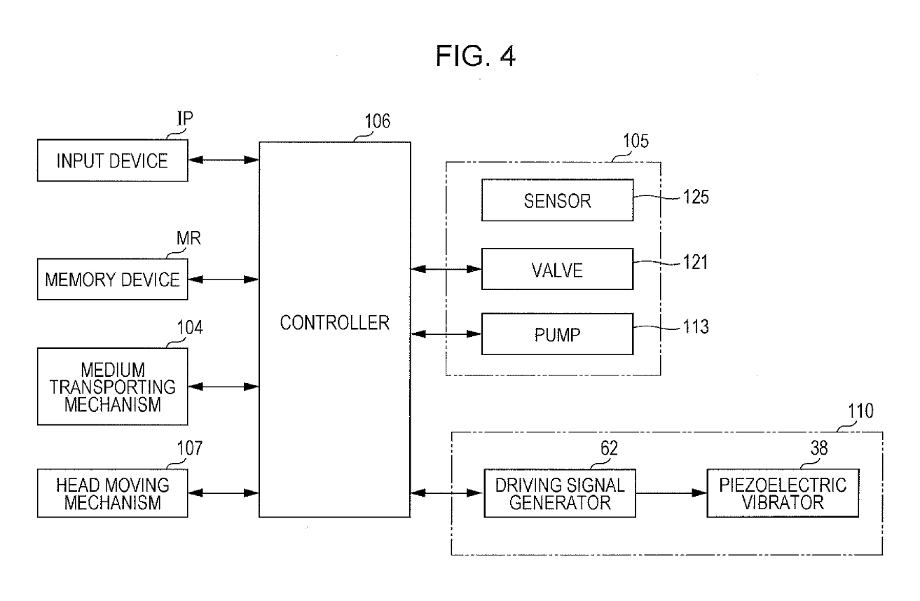

FIG. 4 is a block diagram illustrating the electrical configuration of the printer 100. The printer 100 includes the above-described controller 106 which controls the operations of the entirety of the printer 100. An input device IP and a memory device MR are connected to the controller 106. Various information relating to the operation of the printer 100 is input through the input device IP. Various information relating to the operation of the printer 100 is stored in the memory device MR. Furthermore, the medium transport mechanism 104, the head movement mechanism 107, the maintenance mechanism 105 including the valve 121, the suction mechanism 113, the sensor 125, and the like are connected to the controller 106. A driving signal is applied to the piezoelectric vibrator 38 via the driving-signal generator 62, in such a manner that the controller 106 performs a control operation in which a predetermined amount of ink is discharged from the nozzles 47.

Next, the operation of the printer 100 having the configuration described above will be described.

When a job command for starting printing is input, the controller 106 drives the medium transport mechanism 104 so as to transport the medium M and voltage is applied to the piezoelectric vibrator 38 via a driving-signal generator 62 in such a manner that the controller 106 drives the head 110. Accordingly, ink is discharged, from the nozzles 47, onto predetermined positions in the medium M which is transported, by the medium transport mechanism 104, immediately below the head 110, in such a manner that the head 110 performs an intended printing process.

In the printer 100, the ink supply mechanism 103 supplies ink from the ink cartridge 6 to the head 110, during the printing process. Accordingly, the printer 100 continuously ejects ink onto the medium M, and thus the printing process can be continuously performed.

Meanwhile, in this embodiment, the ink discharged from the head 110 is an ink for forming an organic EL element, which has properties such that the quality of the ink is deteriorated when the ink is exposed to light rays. Accordingly, in a path through which ink is supplied from the ink cartridge 6 to the head 110, it is necessary to prevent light rays from being emitted onto the ink. However, the printer 100 of this embodiment has a configuration in which the ink supply portion 50 has light shielding properties throughout the entirety of the ink supply path extending from the ink cartridge 6 to the head 110. As a result, it is possible to prevent the occurrence of a problem of, for example, ink supplied to the head 110 being exposed to light rays in the middle of a transporting path.

Furthermore, to maintain the quality of the printing process, the printer 100 performs a maintenance process relating to the nozzle 47 for each predetermined period. The controller 106 drives, for example, the cap mechanism 112 of the maintenance mechanism 105. Accordingly, the cap mechanism 112 causes the abutment portions 119 of a plurality of cap members 112a to be in close-contact with the discharge surfaces 110a of the heads 110. In this case, The head 110 may be driven to move close to the cap member 112a.

The controller 106 drives the suction mechanism 113 and the space between the cap member 112a and the discharge surface 110a enters a negative pressure state, in such a manner that The controller 106 performs a suction operation in which ink is forcibly emitted from the nozzles 47 through the tube 114 (the branch portion 120).

When the suction operation described above is finished, the maintenance mechanism 105 performs a wiping process in which the wiping member wipes the discharge surface 110a. Furthermore, the maintenance mechanism 105 performs a flushing process in which ink is forcibly emitted from the respective nozzles 47 into the flushing box of the flushing mechanism 115.

Hereinafter, the suction operation will be mainly described.

The valve 121 corresponding to the cap member 112a which generates a negative pressure is controlled, by the controller 106, to open. In addition, the valve 121 corresponding to the cap member 112a which does not generate a negative pressure is controlled, by the controller 106, to be closed. Opening/closing of the valve 121 is controlled as described above, in such a manner that the cap member 112a connected to the suction mechanism 113 can be switched.

Therefore, in the tube 114 connected to a plurality of cap members 112a, the suction mechanism 113 can be used as a common suction mechanism. As a result, it is possible to reduce the number of parts and reduce costs. Furthermore, since a negative pressure can be selectively generated with respect to only a predetermined head 110, it is possible to suppress the drive load of the suction mechanism 113.

The ink emitted into the cap member 112a flows to the downstream side of the tube 114. At this time, the sensor 125 provided in the connection portion 120b adjacent to the cap member 112a detects the flow condition of ink flowing in the connection portion 120b. In the connection portion 120b of this embodiment, the installation area 125A of the sensor 125 is transparent or semi-transparent. Thus, the upstream-side sensor 125a and the downstream-side sensor 125b image ink at two positions in the connection portion 120b, in such a manner the sensor 125 detects the ink flow condition. Then the sensor 125 sends the detection result to the controller 106.

The controller 106 determines the ink flow condition in the tube 114 (the connection portion 120b), based on the detection result (the captured image) sent from the sensor 125. Specifically, the controller 106 can check the flow velocity of ink sucked from the head 110 or the amount of air-bubbles in the ink, based on the captured image of the ink in the connection portion 120b. When the controller 106 cannot check an ink flow in the connection portion 120b, the controller 106 determines that ink was not emitted from the head 110 by the suction operation. Furthermore, when the flow velocity of ink in the connection portion 120b is appropriate, the controller 106 determines that ink is favorably emitted from the head 110 by the suction operation, that is, the suction operation is performed normally.

In this embodiment, since the sensor 125 is provided in the area upstream from the valve 121, it is possible to detect the ink flowing from the respective heads 110 to the tube 114 (the connection portion 120b) via the cap members 112a. As a result, it is possible to easily and reliably determine whether the ink supply condition with respect to the respective heads 110 is normal.

Meanwhile, when the flow velocity of ink is not appropriate in the connection portion 120b, the controller 106 determines that the ink supply condition with respect to the head 110 is not in a normal state.

The controller 106 adjusts the suction amount of the suction mechanism 113 such that ink supply condition (the ink emission condition with respect to the inner portion of the cap member 112a) with respect to the head 110 returns to normal. In this case, since the amount of negative pressure generated is appropriately adjusted in accordance with the ink flow condition in the connection portion 120b, the ink supply condition with respect to the head 110 can return to normal.

Furthermore, the controller 106 may separately adjust the opening/closing amounts of the respective valves 121, in addition to the adjustment of the suction amount of the suction mechanism 113, such that the ink supply condition with respect to the head 110 returns to a normal state. In this case, since the opening/closing amount of the valve 121 is adjusted, the amount of negative pressure generated is optimized for each head 110. As a result, it is possible to return the ink supply condition to a normal state.

In the printer 100 according to this embodiment, it is possible to determine the flow condition of a photoreactive ink flowing in the ink emission path 112A of the cap mechanism 112, as described above. Accordingly, it is possible to check, for example, the flow velocity of ink which is sucked out from the head 110 or the amount of air-bubbles in the emitted ink. As a result, it is possible to confirm whether the ink supply condition with respect to the head 110 is normal.

An example in which the flow condition of the ink which is forcibly emitted from the nozzles 47 of the head 110 by the suction operation is determined is applied to the embodiment described above. However, the invention is not limited thereto. When the initial filling of the head 110 with ink is performed using the cap mechanism 112, the ink supply condition with respect to the head 110 may be determined based on the detection result from the sensor 125.

In other words, When the initial filling of the head 110 with ink finishes normally, the sensor 125 detects the ink emitted from the nozzles 47 of the head 110 to the cap member 112a. On the contrary, when the initial filling of the head 110 with ink does not finish normally, the ink is not emitted to the cap member 112a. Thus, the sensor 125 cannot detect the ink.

An example in which the entirety of the tube 114 is transparent or semi-transparent is applied to the embodiment described above. However, only a part (which is an observation area) of the tube 114, in which the sensor 125 is provided, may have transparency or semi-transparency and the remaining portion of the tube 114 may have light shielding properties.

An example in which the sensor 125 detects the ink flowing in the tube 114 is applied to the embodiment described above. However, a user visually inspects the ink flow condition in the tube 114, in such a manner that whether cleaning in the head 110 is performed normally or whether the initial filling of the head 110 with ink is performed normally may be determined in such.

### Embodiment 2

Next, a cap mechanism according to Embodiment 2 will be described. A difference between this embodiment and Embodiment 1 is a sensor installation position in an ink emission path with the other configurations being the same. Accordingly, in the following description, the same reference numerals and letters are given to components or members of which the configurations are the same as those in the embodiment described above. The detailed descriptions thereof will not be repeated or will be simplified.

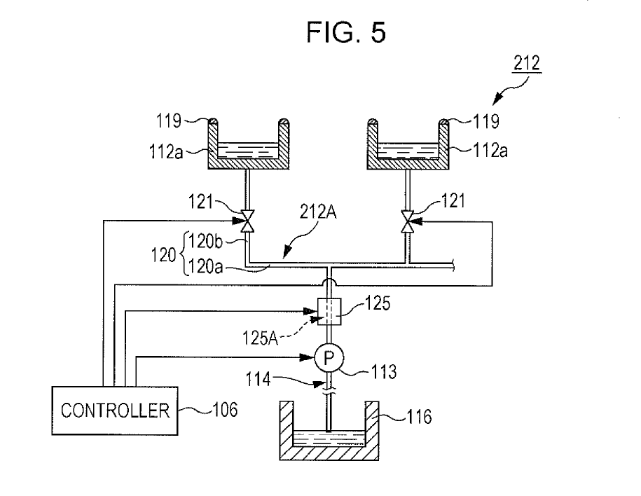

FIG. 5 is a view illustrating the configuration of a cap mechanism 212 according to Embodiment 2. Similarly to Embodiment 1, the cap mechanism 212 of this embodiment includes an ink emission path (the second ink path) 212A through which the ink emitted from the head 110 flows, as illustrated in FIG. 5.

In this embodiment, only one sensor 125 is disposed, in the tube 114, in a portion between the connection portion 120b and the suction mechanism 113.

Next, the operation of the cap mechanism 212 will be mainly described as a printing operation of this embodiment.

The controller 106 controls opening/closing of the valve 121, in such a manner that the controller 106 can cause ink to be emitted from the head 110 on which a predetermined cap member 112a abuts. The ink emitted into the respective cap members 112a flows to the downstream side of the tube 114. At this time, the sensor 125 provided in the portion between the branch portion 120 and the suction mechanism 113 detects the flow condition of the ink flowing in the tube 114.

In the tube 114 of this embodiment, similarly to Embodiment 1, only the installation area 125A of the sensor 125 is transparent or semi-transparent. Thus, the sensor 125 images the ink flowing in the tube 114, in such a manner that the sensor 125 detects the ink flow condition. Then, the sensor 125 sends the detection result to the controller 106.

The controller 106 determines the ink flow condition in the tube 114, based on the detection result (the captured image) sent from the sensor 125.

In this embodiment, similarly to Embodiment 1, it is possible to detect the flow condition of the ink which flows from the respective heads 110 to the tube 114 via the cap members 112a. As a result, it is possible to easily and reliably determine whether the ink supply condition with respect to the respective heads 110 is normal.

In this embodiment, since only one sensor 125 is provided in the area downstream from the valve 121, the controller 106 controls opening/closing of the valve 121, in such a manner it is possible to switch the cap member 112a connected to the sensor 125. Accordingly, in the ink emission path 212A connected to the plurality of cap members 112a, the sensor 125 can be used as a common cap member. As a result, it is possible to reduce the number of parts and reduce costs.

### Embodiment 3

Next, a cap mechanism according to Embodiment 3 will be described. A difference between this embodiment and Embodiment 1 is a suction mechanism installation position in an ink emission path with the other configurations being the same. Accordingly, in the following description, the same reference numerals and letters are given to components or members of which the configurations are the same as those in the embodiment described above. The detailed descriptions thereof will not be repeated or will be simplified.

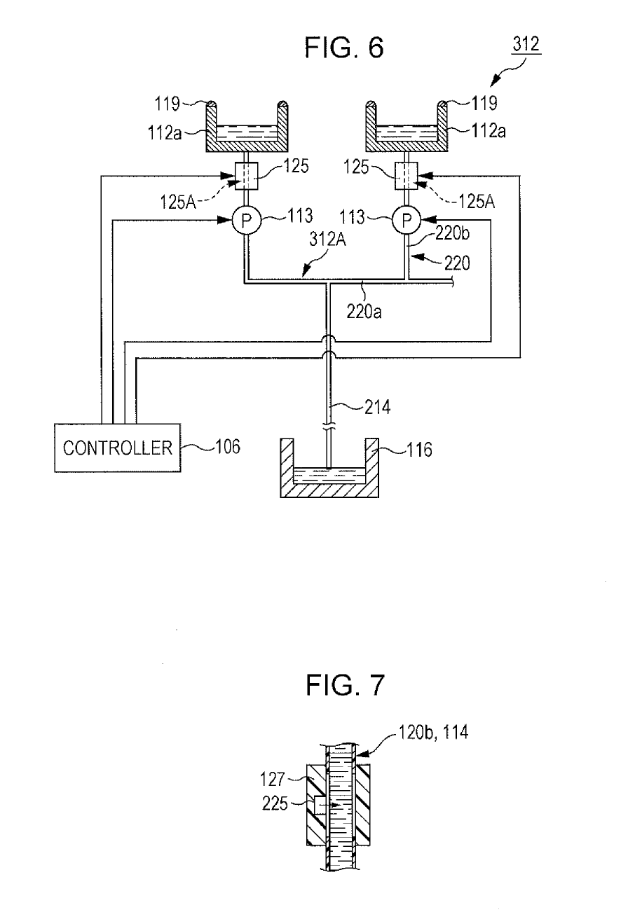

FIG. 6 is a view illustrating the configuration of a cap mechanism 312 according to Embodiment 3. Similarly to the embodiments described above, the cap mechanism 312 of this embodiment includes an ink emission path (the second ink path) 312A through which the ink emitted from the head 110 flows, as illustrated in FIG. 6.

The cap mechanism 312 of this embodiment includes a plurality of cap members 112a, a plurality of suction mechanisms 113, and a tube 214. One end side of the tube 214 is connected to the waste-ink tank 116. The waste-ink tank 116 recovers, through the tube 214, the ink which is emitted into the cap member 112a by the suction operation of the suction mechanism 113. In other words, the tube 214 constitutes a part of the ink emission path 312A for recovering waste ink.

The tube 214 has a branch portion 220 provided on the other end side thereof. The branch portion 220 includes a main portion 220a and connection portions 220b connected to the main portion 220a. The number of the connection portions 220b is the same as the number of the cap members 112a. In this embodiment, the number of the connection portions 220b is four. The illustration is simplified in FIG. 6. Accordingly, only two connection portions 220b are illustrated in FIG. 6.

In this embodiment, the suction mechanism 113 is provided for each connection portion 220b. In addition, the sensor 125 is provided, in each of the connection portions 220b, in a portion between the suction mechanism 113 and the cap member 112a. Similarly to the embodiments described above, the tube 214 of this embodiment is constituted of a black tube having light shielding properties, except for some parts thereof described below.

In the connection portions 220b of this embodiment, similarly to the embodiments described above, only the installation area 125A of the sensor 125 is transparent or semi-transparent. In the installation area 125A having transparency or semi-transparency, the sensor 125 detects the flow velocity of ink flowing in the tube 214.

Next, the operation of the cap mechanism 312 will be mainly described as a printing operation of this embodiment.

The controller 106 drives the suction mechanism 113 which is provided to correspond to each cap member 112a, in such a manner that the controller 106 causes ink to be emitted from the head 110 on which the cap member 112a abuts. The ink emitted into the respective cap members 112a flows to the downstream side of the tube 214 via the connection portions 220b. At this time, the sensor 125 provided in the portion between the cap member 112a and the suction mechanism 113 detects the flow condition of the ink flowing in the tube 214.

In the tube 214 of this embodiment, similarly to Embodiment 1, only the installation area 125A of the sensor 125 is transparent or semi-transparent. Thus, the sensor 125 images the ink flowing in the tube 214, in such a manner that the sensor 125 detects the ink flow condition. Then, the sensor 125 sends the detection result to the controller 106.

The controller 106 determines the ink flow condition in the tube 214, based on the detection result (the captured image) sent from the sensor 125.

In this embodiment, similarly to the embodiments described above, it is possible to detect the flow condition of the ink which flows from the respective heads 110 to the tube 214 via the cap members 112a. As a result, it is possible to easily and reliably determine whether the ink supply condition with respect to the respective heads 110 is normal.

Furthermore, in this embodiment, the controller 106 controls, based on the detection result from the sensor 125, the suction mechanism 113 which is provided to correspond to each cap member 112a. In this case, the suction mechanism 113 is controlled in accordance with the detection result from the sensor 125, in such a manner that the amount of negative pressure generated can be appropriately adjusted in accordance with the ink flow condition in the respective connection portions 220b. Accordingly, the ink supply condition with respect to the respective heads 110 can return to normal.

Meanwhile, an example in which an ink containing a forming material of an organic EL element is used as a photoreactive ink discharged from the head 110 is applied to the embodiments described above. However, without being limited thereto, an ultraviolet-ray curing type ink may be used as a photoreactive ink discharged from the head 110.

In Embodiment 1 described above, there is a concern that light rays may enter the installation area 125A of the sensor 125 from outside and the ink flowing in the installation area 125A may be exposed to the light rays. In this case, when the ink containing a forming material of an organic EL element is exposed to light rays, the quality of the ink is deteriorated. However, the exposed ink is not cured or condensed, and thus a problem, such as clogging of a flow path with ink, is prevented from occurring. In other words, even when the ink is exposed to light rays, the flowability (the flow velocity) of the ink does not change.

However, in the case of an ultraviolet-ray curing type ink, when the ink is exposed to light rays, the ink is cured. Accordingly, clogging of a flow path with ink occurs. In other words, the flowability of ink changes due to light exposure.

### Modification Example

Hereinafter, the configuration of a sensor of the modification example, in which an ultraviolet-ray curing type ink is used as an ink, will be described.

FIG. 7 is a view illustrating the configuration of the sensor of the modification example.

In the modification example, a light-shielding material 127, such as a black resin, covers the periphery of a sensor 225 provided in the tube 114 (the connection portion 120b), as illustrated in FIG. 7. Accordingly, it is possible to prevent a problem that light rays may enter the installation area of the sensor 225 from outside and the ink flowing in the tube may be exposed to the light rays. As a result, it is possible to prevent clogging of a tube with ink, resulting from the cured ink in the tube.

When a sensor of a type in which a light ray for detecting the ink flow condition is emitted to ink is used as the sensor 225 described above, a light ray having a wavelength band different from the wavelength band in which the ink is cured may be emitted as a light ray for detection. In this case, even when the sensor 225 emits a light ray for detection into the tube 114, in such a manner that the sensor 225 detects the ink flow condition, the flowability of ink does not change and, further, it is possible to prevent a problem, such as clogging of a tube with ink.

Hereinbefore, the embodiments of the invention are described. However, the invention is not intended to be limited thereto. The invention can be appropriately modified as long as it does not depart from the spirit of the invention.

An example in which the printer 100 is used as an ink jet system is applied to the embodiments described above. However, without being limited thereto, a copying machine or a facsimile machine may be used as an ink jet system.

The entire disclosure of Japanese Patent Application No. 2014-055040, filed Mar. 18, 2014 is expressly incorporated by reference herein.

What is claimed is:

1. An ink jet system comprising:
an ink supply mechanism which supplies a photoreactive ink to an ink jet head; and
an ink recovery mechanism which recovers the photoreactive ink emitted from the ink jet head,
wherein the ink supply mechanism includes a first ink path through which the photoreactive ink flows,
wherein the ink recovery mechanism includes a second ink path through which the photoreactive ink flows,
wherein the first ink path has light shielding properties, and
wherein an observation area through which the photoreactive ink flowing in the second ink path can be observed is provided in at least a part of the second ink path.

2. The ink jet system according to claim 1,
wherein the photoreactive ink is an ink for forming an organic electroluminescence element.

3. The ink jet system according to claim 1,
wherein a detection portion is provided in the observation area to detect the flow condition of the photoreactive ink.

4. The ink jet system according to claim 1,
wherein the photoreactive ink is an ultraviolet-ray curing type ink.

5. The ink jet system according to claim 4,
wherein a detection portion for detecting the flow condition of the photoreactive ink and a light-shielding material covering the outer surface of the detection portion are provided in the observation area.

6. The ink jet system according to claim 4,
wherein the ink recovery mechanism includes,
a plurality of cap members which can abut a plurality of the ink jet heads,
a negative pressure generating unit which causes a portion between the cap member and the ink jet head to enter a negative pressure state, and
a valve which is provided in the second ink path connecting the cap member and the negative pressure generating unit.

7. The ink jet system according to claim 6,
wherein a plurality of the detection portions are disposed further on the upstream side of the second ink path than the valve, to correspond to the plurality of cap members.

8. The ink jet system according to claim 7,
wherein a plurality of the negative pressure generating units are provided to correspond to the plurality of cap members, and
wherein the ink jet system further comprises a control portion which controls the negative pressure generating units based on the detection results from the plurality of detection portions.

9. The ink jet system according to claim 6,
wherein the detection portion is disposed further to the downstream side of the second ink path than the valve.
